(19) United States
(12) Patent Application Publication
(10) Pub. No.: US 2010/0229199 A1
(43) Pub. Date: Sep. 9, 2010

(54) APPARATUS AND METHOD FOR DISPLAYING ELECTRONIC PROGRAM GUIDE

(76) Inventor: Kyoung Won Park, Gyoungsangbuk-do (JP)

Correspondence Address: KED & ASSOCIATES, LLP, P.O. Box 221200, Chantilly, VA, 20153-1200, US

(21) Appl. No.: 12/446,544

(22) PCT Filed: Oct. 17, 2008
(86) PCT No.: PCT/KR08/06174

§ 371 Date: Apr. 21, 2009

(30) Foreign Application Priority Data
Oct. 23, 2007 (KR) 10-2007-0106442

(51) Int. Cl. H04N 5/445

(52) U.S. Cl. 725/44

(57) ABSTRACT

An apparatus for displaying Electronic Program Guide (EPG) includes a storage configured to store a broadcast program information comprising an information of broadcast channels, a controller configured to group the broadcast channels by channels which have a major channel number that is identified with each other channels, and display a representative channel selected among the grouped channels on an EPG screen, and a display configured to display the EPG screen on which a broadcast program information of the representative channel is displayed.

### TECHNICAL FIELD

The present disclosure relates to an image display apparatus, and in particular, to a method for displaying Electronic Program Guide (EPG) which includes at least one broadcast program information. More particularly, the present disclosure relates to a channel classifying method which classifies channels to be displayed on the EPG, and a channel grouping apparatus and method, which group channels to be displayed on the EPG.

### BACKGROUND ART

In video broadcast and process application, digital video data are commonly encoded to meet requirements of the known standard. One of widely adopted standards is the Moving Picture Experts Group-2 (MPEG-2) image encoding standard. The MPEG standard is configured with a system encoding paragraph (ISO/IEC 13818-1, Jun. 10, 1994) and a video encoding paragraph (ISO/IEC 13818-2, Jan. 20, 1995).

Data encoded into the MPEG standard have a packetized datastream type including data contents of many program channels (for example, contents corresponding to cable television channels 1-125). In addition, some digital services and channels could have frequency spectrum occupied by a single analog channel. The 6 MHz bandwidth which has been allotted to analog National Television System Committee (NTSC) compatible broadcast channels can be divided into a plurality of digital sub-channels providing various services. For example, the broadcast spectrum of a Radio Frequency (RF) channel 13 can be allotted to sub-channels including main program channels, finance service channels providing stock quotations, sport news service channels, and shopping and interactive channels. In addition, the number of transmitted sub-channels and bandwidths of respective sub-channels are dynamically changed for meeting broadcast programming requirements.

In such a digital video system, broadcast stations can dynamically change the number of channels and allotted bandwidths, and a Multi Mode Service (MMS) broadcast is provided that establishes and broadcasts one or more logical channels through one physical channel.

Herein, the MMS broadcast means that approximately three to twenty logical channels such as a service of Standard Definition (SD) class, a data service and a single audio service are commonly multiplexed into one physical channel and the multiplexed physical channel is transmitted.

In the above-described broadcast services, expansion of the number of services and increment of a diversity of service contents lead to many problems upon service use of users.

Particularly, increment of the number of broadcast channels increase difficulties for tuning and the time taken in acquisition of a selected program channel.

### DISCLOSURE

### Technical Problem

Embodiments provide an apparatus and method for displaying Electronic Program Guide (EPG), which provide information of broadcast channels in a tree type, thereby enabling users to easily search and determine information of a desired program channel using the EPG.

Embodiments also provide an apparatus and method for displaying EPG, which edit and group respective logical channels on the basis of major channel numbers included in the logical channels from transmitted EPG information, thereby enabling the edited channel information to be displayed on the EPG.

### Technical Solution

In one embodiment, an apparatus for displaying Electronic Program Guide (EPG) includes: a storage configured to store a broadcast program information comprising an information of broadcast channels; a controller configured to group the broadcast channels by channels which have a major channel number that is identified with each other channels, and display a representative channel selected among the grouped channels on an EPG screen; and a display configured to display the EPG screen on which a broadcast program information of the representative channel is displayed.

In another embodiment, an apparatus for displaying EPG includes: a receiver configured to receive a broadcast signal comprising broadcast information; a storage configured to store the broadcast information; a controller configured to analyze major channel numbers of logical channels, grouping the logical channel on the basis of the major channel number, and selecting any one of the logical channels as a representative channel; an EPG manager configured to generate an EPG screen comprising broadcast program information of the representative channel; and a display displaying the EPG screen.

In further another embodiment, a method for displaying EPG includes: receiving and storing broadcast information; analyzing an information of each broadcast channel from the stored broadcast information to extract a major channel number of the each broadcast channel as characteristic information of the broadcast channel; grouping broadcast channels which commonly use the extracted major channel number into a single group; and selecting any one of the grouped broadcast channels as a representative channel, and displaying the representative channel of the broadcast channels forming the group on an EPG screen.

The details of one or more embodiments are set forth in the accompanying drawings and the description below. Other features will be apparent from the description and drawings, and from the claims.

### ADVANTAGEOUS EFFECTS

Embodiments enable users to easily distinguish between physical channels or logical channels through an Electronic Program Guide (EPG) according to embodiments.

Embodiments group logical channels on the basis of major channel numbers included in the logical channels and display representative channel on the EPG, thereby hiding channels such as lower channels where main programs are not broadcast or channels such as audio channels which have a little program information whereas occupy a large area.

In embodiments, respective channels of channel information displayed on an EPG screen include representative channels, thereby enabling users to selectively search logical channels.

### DESCRIPTION OF DRAWINGS

FIG. 1 is a block diagram of an image display apparatus according an embodiment.

FIG. 2 is an exemplary diagram of an EPG screen provided to users according to an embodiment.

FIG. 3 is a flowchart for describing a method for displaying EPG according to an embodiment.

FIG. 4 is a flowchart for describing the editing and grouping operations of broadcast channels according to an embodiment.

### BEST MODE

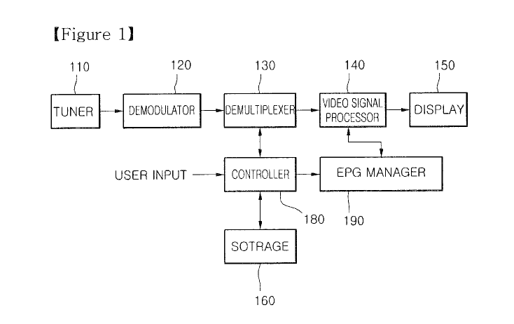

Reference will now be made in detail to the embodiments of the present disclosure, examples of which are illustrated in the accompanying drawings. FIG. 1 is a block diagram of an image display apparatus according an embodiment. The image display apparatus is disclosed as a broadcast receiver receiving a Radio Frequency (RF) broadcast signal, but the present invention is limited to this embodiment. An embodiment can be applied to a terrestrial broadcast system, a cable broadcast system, a satellite broadcast system, an Internet broadcast system and a computer network broadcast system. For example, the broadcast systems may include a non-MPEG compatible system of receiving other type of encoded datastream and program characteristic information in other scheme.

Referring to FIG. 1, the image display apparatus includes a tuner 110 which is a receipt unit for receiving an external broadcast signal and selects a broadcast signal of a channel which a user desires, a demodulator 120 for demodulating and correcting the broadcast signal selected through the tuner 110 to change the selected broadcast signal into a transport stream type, a demultiplexer 130 for demultiplexing the temporally multiplexed transport stream input through the demodulator 120 to divide the transport stream into audio information, video information and additional information, and a image signal processor 140 for decoding an image signal input through the demultiplexer 130, changing the decoded image signal to be suitable for an outputtable display format and outputting the changed signal.

The image display apparatus includes a display 150 for displaying an image signal, a storage 160 for storing the additional information divided through the demultiplexer 130, a controller 180 for extracting and analyzing broadcast information stored in the storage 160, and classifying and grouping broadcast channels according to the analyzed channel information, and an Electronic Program Guide (EPG) manager 190 for generating an EPG including the grouped information according to the controller 180.

A collation process of program information for forming the EPG from a received broadcast signal will be described in detail below.

A data packet of a transport stream including a user selection program channel is identified and assembled with program characteristic information.

Accordingly, an EPG information collation by the controller 180 can be achieved by using program characteristic information from a data signal which is transmitted in the transport stream type. The program characteristic information may include data supporting the identification and assembly of incidental EPG information, and descriptions associated with incidental EPG information and broadcast programs.

Additionally, a hierarchy table array includes optional tables such as a Master Guide Table (MGT), a Channel Information Table (CIT), an Event Information Table (EIT), and an Extended Text Table (ETT).

The MGT includes information for acquiring specific information being program information, which is transferred to a table, such as an identifier for identifying a data packet associated with other table. The CIT includes information for tuning navigation in order to receive the user selection program channel. The EIT includes a description list of receivable program of channels arranged in the CIT. The ETT includes messages describing programs and program channels. Additional program characteristic information for describing and supplementing items in the hierarchy table is transferred to descriptor information elements. In an embodiment, the controller 180 controls the EPG manager 190 in order to form an EPG to be provided to a user using received additional information. Particularly, broadcast channels displayed on the EPG are representative channels which are classified on the basis of the major channel numbers of logical channels.

In the logical channel and a physical channel discriminated from the logical channel, an RF channel or a Physical Transmission Channel (PTC, or physical channel) denotes an allotted broadcast station transmission channel band including one or more sub-channels (called a virtual channel or a logical channel).

The virtual channel or the logical channel has a major channel number and a minor channel number. A single broadcast station forms a plurality of identifiable logical channels in one physical channel.

For example, in a case where a physical channel includes two logical channels 11-1 and 11-2, each of the two logical channels 11-1 and 11-2 has a major channel number and a minor channel number. Herein, the number 11 being a common number of the logical channel is the major channel number of the logical number, and the respective numbers 1 and 2 displayed next to the major channel number is the minor channel number of the logical channel.

Accordingly, in the existing Digital Television (DTV), all logical channels (including broadcast programs) such as the logical channels 11-1 and 11-2 are displayed on the EPG. However, since very many logical channels are formed in recent, users have difficulty in selecting a channel in a case where all channels including broadcast programs are displayed.

In description below, a physical channel corresponding to a frequency band allotted to a broadcast station will be discriminated from a logical channel formed in the physical channel, and a major channel number and a minor channel number which are formed in the logical channel will be discriminated from each other.

In this viewpoint, the controller 180 extracts and analyzes information to form the EPG from received additional information. Herein, the grouping of logical channels is performed on the basis of the major channel numbers of the logical channels.

The information of the grouped result is displayed on the EPG which is displayed on the display 150 through the EPG manager 190, and the grouped logical channels are sequentially expanded and displayed according to a selection of a user.

Accordingly, when a user input is an EPG display command, the controller 180 extracts additional information stored in the storage 160 and performs control for an EPG screen to be displayed on the basis of the extracted additional information. At this point, the EPG manager 190 generates the EPG screen on the basis of the additional information.

Herein, channel information displayed on the EPG on a screen is a representative channel for channels which are classified and grouped on the basis of the major channel numbers of the logical channels, and the remaining logical channels are formed as a lower level of the representative channel.

Even in a case where logical channels having different major channel numbers are included in a specific physical channel, the respective logical channels may be grouped on the basis of the major channel numbers.

For example, in a case where a first physical channel includes a channel 11-1 (a first logical channel), a channel 11-2 (a second logical channel), a channel 13-4 (a third logical channel) and a channel 13-5 (a fourth logical channel), since an embodiment groups channels on the basis of major channel numbers included in a logical channel, the first and second logical channels are edited to be included in the same group and the third and fourth logical channels are also edited to be included in the same group.

The grouped result need be displayed on the EPG screen in order for a user to see it. This is for displaying only the representative channel selected through the grouping process on the EPG screen.

For example, the first and second logical channels are grouped into the same group. At this point, among the first and second logical channels, the logical channel having the foremost minor channel may be selected as a representative channel.

In this case, only broadcast information of the first logical channel 11-1 is displayed on the EPG screen, and a grouping mark, which enables a user to see information of the grouping of other logical channels, may further be formed in an area adjacent to an area on which the broadcast information of the first logical channel is displayed.

The grouping mark is for providing additional broadcast program information to the user, and may be implemented with special signs, characters, images and the like.

As a result, the program information of tens to hundreds logical channels is not all displayed an EPG screen, and only the program information of representative channels according to the grouping is displayed on the EPG screen.

Accordingly, a user can reduce the load to search tens to hundreds channels in order to select specific channels.

Herein, the representative channels seen to the user may be channels having a history viewed by the user, or channels through which the programs of genre of interest preset by the user are intended to be broadcast.

To provide more simplified EPG screen to users, a method is disclosed which groups the logical channels, and a logical channel corresponding to the preference or requirement of the users may be a representative channel when the representative channel is selected herewith.

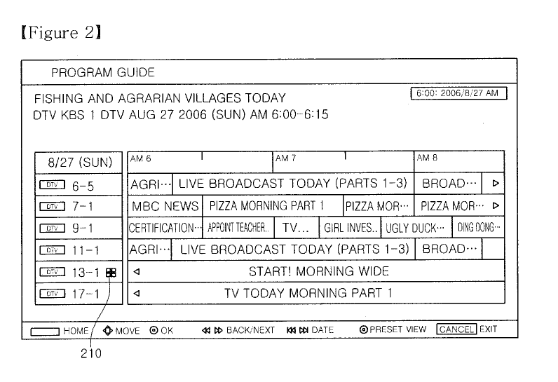

FIG. 2 is an exemplary diagram of the EPG screen provided to users according to an embodiment. If a current channel has channel numbers 6-5, 7-1, 9-1, 11-1, 13-1, 13-2, 13-3 and 17-1, only the channel information of the channel numbers 6-5, 7-1, 9-1, 11-1, 13-1 and 17-1 is displayed on the EPG screen based on the representative channel generated through the EPG manager 190, and the channel numbers 13-2 and 13-3 are respectively grouped into a lower channel of the channel number 13-1 having the same major channel number. In other words, in a case where logical channels having a major channel number 1 are LCN1, LCN10, LCN11, LCN12, LCN14, LCN15 and LCN100 and logical channels having a major channel number 2 are LCN2, LCN21, LCN22, LCN23, LCN25, LCN26 and LCN200, only the logical channels LCN1 and LCN2 are respectively displayed on the EPG screen provided to users, and the logical channels LCN10, LCN11, LCN12, LCN14, LCN15 and LCN100 and the logical channels LCN21, LCN22, LCN23, LCN25, LCN26 and LCN200 are grouped into the lower channel of the logical channels LCN1 and LCN2.

In FIG. 2, a plus image + is illustrated as a grouping mark 210 for informing the grouping result of the channels. Accordingly, when a user selects the grouping mark 210, the controller 180 controls the EPG manager 190 in order to display information of a corresponding representative channel and other logical channels classified in the same group. Consequently, an On Screen Display (OSD) screen may further be formed in which program information of dependent logical channels is recorded.

The OSD screen informs that the dependent logical channels further exist, and it may also display the additional information of grouped lower logical channels. That is, if there exists preset information (preset record/preset view) set by a user for a lower logical channel that is not selected as a representative channel, the preset information may be displayed on the OSD screen.

Specific information of a lower logical channel, i.e., specific information such as whether the lower logical channel is a channel associated with the representative channel or a separate other channel and whether the lower logical channel, is a music channel associated with a music broadcast may be displayed on the OSD screen, and information of the number of grouped lower logical channels may be displayed.

Since an audio channel has approximately at least thirteen channels, the approximately thirteen channels are grouped and displayed on the basis of one main channel, thereby enhancing users visibility.

When a user selects a specific channel of channel information displayed on the EPG screen, detail information of the specific channel selected by the user is displayed.

That is, when there is no lower channel of the selected specific channel, detail information of the selected channel is displayed. When there is a lower channel of the selected specific channel, program information of grouped lower logical channels is displayed.

For example, when a user selects the channel number 13-1 on the EPG screen of FIG. 2, information of the lower logical channels of the channel numbers 13-2 and 13-3 is displayed because there exist the same lower logical channel as the major channel number of the channel number 13-1.

At this point, when information of the lower logical channels is displayed, only the number of a logical channel having the same major channel number as the selected representative channel may be displayed, and the channel information of the channel numbers 13-2 and 13-3 succeeding the channel number 13-1 may be displayed in a structure of a tree type.

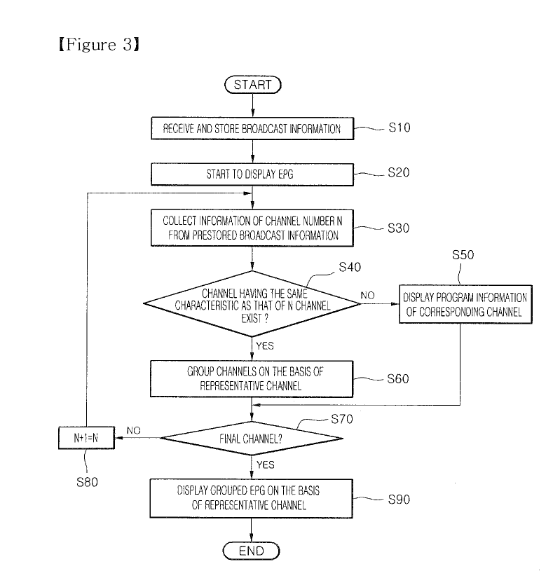

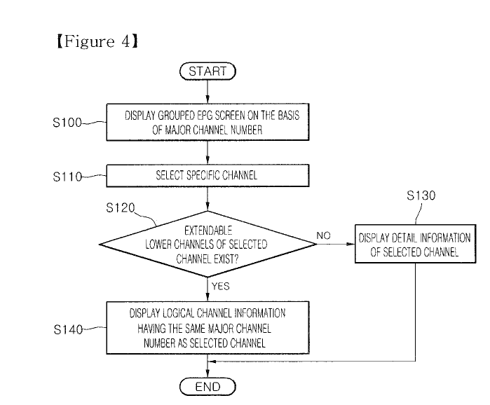

FIG. 3 is a flowchart for describing a method for displaying EPG according to an embodiment. FIG. 4 is a flowchart for describing the editing and grouping operations of broadcast channels according to an embodiment.

Referring to FIG. 4, the EPG display apparatus receives and stores a broadcast signal including external broadcast information (additional information) in operation S10. When a user requests EPG display, the EPG display apparatus collects and analyzes channel information of a channel number N from the prestored broadcast information for starting to display the EPG in operations S20 and S30.

The EPG display apparatus determines whether there exist logical channels having the same characteristics as those of the analyzed channel number N in operation S40. That is, the EPG display apparatus determines whether there exist other logical channels including the same major channel number as the logical channel number N.

When the determination result shows that there exist no logical channel having the same physical channel number as the channel number N, the EPG display apparatus displays channel information of a corresponding channel in operation S50.

When the determination result shows that there exists a logical channel having the same channel characteristics (major channel number) as the channel number N, the EPG display apparatus groups the remaining logical channels on the basis of the major channel number in operation S60. Subsequently, the EPG display apparatus determines whether the channel is a final channel in operation S70. When a corresponding channel is the final channel, the EPG display apparatus displays a representative channel being a result material into which the channels are grouped on the basis of the channel number of the logical channel on the EPG screen in operation S90.

When the channel is not the final channel, the EPG display apparatus returns to the operation S30 for forming an EPG screen for a successive channel N+1? Referring to FIG. 4, as illustrated in FIG. 3, the EPG display apparatus groups logical channels which commonly use a major channel number of a logical channel as channel characteristic information, and displays a representative channel generated according to the grouping on an EPG screen in operation S100.

When a user selects a specific channel displayed on the EPG screen in operation S110, the EPG display apparatus determines whether there exist the extendable lower channels for the selected channel in operation S120. That is, the EPG display apparatus determines whether there exists the same other logical channel as a major channel number of the selected logical channel.

When the determination result shows that there are no extendable lower channels for the channel, the EPG display apparatus displays the detail information of the selected channel in operation S130.

On the other hand, when the determination result shows that there are extendable lower channels for the channel, the EPG display apparatus displays information of a logical channel having the same major channel number as the selected channel in operation 5140. That is, the EPG display apparatus displays the channel information of logical channels that are grouped on the basis of the same physical channel number as described above.

At this point, a method of displaying the channel information of the logical channels may display only the same logical channel information as the major channel number of the selected channel and display the channel information in a structure of the tree type as described above.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

Since embodiments are embodied in electronic devices capable of displaying an Electronic Program Guide (EPG), they have industrial applicability.

1. An apparatus for displaying Electronic Program Guide (EPG), comprising:
a storage configured to store a broadcast program information comprising an information of broadcast channels;
a controller configured to group the broadcast channels by channels which have a major channel number that is identified with each other channels, and display a representative channel selected among the grouped channels on an EPG screen; and
a display configured to display the EPG screen on which a broadcast program information of the representative channel is displayed.

2. The apparatus of claim 1, wherein the controller displays a grouping mark on the EPG screen when at least one broadcast channel is categorized as a lower channel of the representative channel.

3. The apparatus of claim 2, wherein the grouping mark is an information of the lower channel, and the controller displays the grouping mark on an On Screen Display (OSD) screen when a recoding of viewing of the lower channel is reserved.

4. The apparatus of claim 2, wherein the grouping mark is an information of the lower channel, and the controller displays the number of the lower channel as the grouping mark on an On Screen Display (OSD) screen.

5. An apparatus for displaying Electronic Program Guide (EPG), comprising:
a receiver configured to receive a broadcast signal comprising broadcast information;
a storage configured to store the broadcast information;
a controller configured to analyze major channel numbers of logical channels, grouping the logical channel on the basis of the major channel number, and selecting any one of the logical channels as a representative channel;
an EPG manager configured to generate an EPG screen comprising broadcast program information of the representative channel; and
a display displaying the EPG screen.

6. The apparatus of claim 5, wherein the controller categorizes logical channels which commonly use the major channel number into the same group, and selects any one of the logical channels classified into a single group as a representative channel to be displayed on an On Screen Display (OSD) screen.

7. The apparatus of claim 6, wherein the controller selects any one of logical channels having a history viewed by a user among logical channels classified into a single group as a representative channel.

8. The apparatus of claim 6, wherein the controller selects any one of logical channels comprising broadcast program of genre of interest preset by a user among logical channels classified into a single group as a representative channel.

9. The apparatus of claim 5, wherein a grouping mark for indicating whether there exists a lower logical channel having the same major channel number as a specific logical channel is displayed on the EPG screen.

10. The apparatus of claim 9, wherein the controller controls an information of the lower logical channel is displayed on the display when the grouping mark is selected by a user.

11. The apparatus of claim 5, wherein an additional information of a lower logical channel having the same major channel number is further displayed on the EPG screen.

12. The apparatus of claim 11, wherein the additional information comprises any one of preset information, characteristic information and number information of the lower logical channel.

13. A method for displaying Electronic Program Guide (EPG), comprising:
receiving and storing broadcast information;
analyzing an information of each broadcast channel from the stored broadcast information to extract a major channel number of the each broadcast channel as characteristic information of the broadcast channel;
grouping broadcast channels which commonly use the extracted major channel number into a single group; and
selecting any one of the grouped broadcast channels as a representative channel, and displaying the representative channel of the broadcast channels forming the group on an EPG screen.

14. The method of claim 13, wherein the selecting of the representative channel comprises selecting a broadcast channel having a history viewed by a user or a broadcast channel having the foremost major channel number among the grouped broadcast channels as the representative channel.

15. The method of claim 13, wherein the selecting and displaying of the representative channel comprise displaying a grouping mark for indicating whether there exist broadcast channels having the same major channel number as the representative channel on the EPG screen.
